(19) United States
(12) Patent Application Publication
(10) Pub. No.: US 2026/0350668 A1
(43) Pub. Date: Nov. 5, 2026

(54) Conditional Escrow Logic and Fulfillment Lockdown for Verified Buyer-Seller Transactions

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/335,937

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.

(51) Int. Cl. G06Q 30/0601; G06Q 10/083

(52) U.S. Cl. CPC G06Q 30/0611; G06Q 10/083

(57) ABSTRACT

A conditional escrow enforcement system that locks fulfillment unless buyer identity, seller trust score, license tier, and jurisdictional rules are validated. The platform blocks unauthorized or premature execution using a combination of metadata analysis, real-time trust scoring, and escrow gating. Execution is only allowed when all conditions are satisfied within the platform-governed environment.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to escrow enforcement systems, and more specifically, to dynamic escrow-locking mechanisms that prevent execution of commercial transactions unless trust, compliance, and escrow triggers are confirmed within a sealed platform.

### BACKGROUND OF THE INVENTION

Traditional escrow systems operate passively and do not enforce transactional locking or real-time validation.

Buyers and sellers can often bypass escrow terms via side channels, resulting in unverified and risky fulfillment.

There is a need for a dynamic, platform-controlled escrow lock system that blocks execution unless all escrow and trust requirements are met.

### SUMMARY OF THE INVENTION

This invention implements conditional escrow logic that actively denies transaction execution until platform-trusted conditions are satisfied.

Escrow lock is enforced based on buyer identity, seller license, metadata verification, jurisdictional clearance, and trust-score validation.

A fulfillment attempt triggers a layered check: if any escrow or trust component fails, the transaction is halted and logged.

The system prevents third-party tools, side apps, or external actors from circumventing the escrow lock.

Escrow status is real-time monitored, and only platform-issued clearances allow progression to fulfillment.

### DETAILED DESCRIPTION OF THE INVENTION

The system comprises a platform-bound escrow verification module.

Each buyer-initiated request is scanned for metadata, user ID, jurisdiction, and linked trust score.

Sellers are cross-verified against a licensing and penalty database.

Transactions are held in escrow staging mode until clearance is achieved.

Escrow lock denial results in a permanent log entry and suspension of unauthorized fulfillment access.

The system integrates fraud scoring, risk analytics, and escrow countdown triggers.

Sellers who attempt to bypass escrow logic are removed from verified tiers.

All successful escrow clearances are time-stamped and linked to platform-issued tokens.

Jurisdictional rules and cross-border fulfillment restrictions are enforced before escrow release.

Escrow logic can be embedded in APIs, vendor dashboards, or mobile apps to ensure compliance.

What is claimed is:

1. A system comprising:
a buyer-initiated escrow trigger;
a seller trust verification engine;
and a fulfillment lock controller that blocks execution unless escrow clearance is validated.

2. The system of claim 1, wherein the escrow trigger includes identity checks, trust scoring, and metadata review.

3. A method comprising:
staging a transaction in escrow mode;
verifying licensing and jurisdictional clearance;
and executing fulfillment only upon complete escrow validation.

4. The system of claim 1, wherein metadata includes location, session ID, vendor license tier, and penalty status.

5. A denial protocol comprising:
failure detection, execution block, and logging of escrow breach attempts.

6. The system of claim 1, wherein escrow logic integrates risk analytics and fraud scoring.

7. A method comprising:
embedding escrow enforcement logic within third-party tools to prevent side-rail fulfillment.

8. The system of claim 1, wherein fulfillment is geo-fenced and escrow-gated simultaneously.

9. A system for escrow-based seller tiering, comprising:
license validation, trust score ranking, and penalty threshold enforcement.

10. A method comprising:
linking escrow tokens to platform identity credentials for transaction tracking.

11. A platform-governed fulfillment engine that only releases escrow upon platform-administered trust clearance.

12. The method of claim 3, wherein vendor clearance includes background check status and regional compliance verification.

13. A transaction denial system comprising:
real-time escrow breach detection, access lockout, and flag escalation.

14. The system of claim 1, wherein sellers are assigned dynamic trust scores impacting escrow clearance windows.

15. A platform-native escrow enforcement module embedded in API calls and vendor dashboards.

16. A system for enforcing jurisdictional escrow restrictions across state, national, and international boundaries.

17. A method comprising:
delaying fulfillment until escrow logs show verified audit trail and compliance triggers.

18. The system of claim 1, wherein time-based escrow thresholds are adjusted based on transaction risk.

19. A seller blacklist engine triggered upon escrow bypass detection or penalty accumulation.

20. A platform escrow control module that governs execution based on dynamic metadata, trust index, and license tier.
